(19) United States
(12) Patent Application Publication
(10) Pub. No.: US 2024/0413552 A1
(43) Pub. Date: Dec. 12, 2024

(54) HIGH DENSITY HYBRID CARD EDGE CONNECTOR

(71) Applicant: Amphenol Commercial Products (Chengdu) Co, Ltd., Chengdu (CN)

(72) Inventor: Shenji Chen, Chengdu (CN)

(73) Assignee: Amphenol Commercial Products (Chengdu) Co, Ltd., Chengdu (CN)

(21) Appl. No.: 18/738,683

(22) Filed: Jun. 10, 2024

(30) Foreign Application Priority Data
Jun. 12, 2023 (CN) 202321489516.8
Dec. 11, 2023 (TW) 112213509

(51) Int. Cl. H01R 12/72; H01R 12/73

(52) U.S. Cl. CPC H01R 12/721; H01R 12/737

(57) ABSTRACT

A high density card edge connector for transmitting signal and power simultaneously. The connector has both signal terminals and power terminals held by a housing with a slot. Each terminal has a mating contact portion disposed in the slot for contacting a voltage regulator module inserted in the slot. A first power terminal is configured for transmitting a first voltage. A number of second power terminals each is configured for transmitting a second voltage. The first power terminal is spaced from the second power terminals by a first spacing. Adjacent second power terminals are spaced from each other by a second pitch less than the first spacing. The first power terminal is spaced from the signal terminals by a third pitch greater than the first spacing. The connector's footprint can fit in a limited space close to a voltage source on a board, enabling more efficient voltage regulation.

### CROSS-REFERENCE TO RELATED APPLICATIONS

This application claims priority to and the benefit of Taiwanese Patent Application No. 112213509, filed on Dec. 11, 2023. This application also claims priority to and the benefit of Chinese Patent Application No. 202321489516.8, filed on Jun. 12, 2023. The contents of these applications are incorporated herein by reference in their entirety.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as several printed circuit boards (PCB) which may be joined together with electrical connectors than to manufacture the system as a single assembly. A known arrangement for joining several PCBs is to have one PCB as a backplane. Then, other PCBs, called “daughterboards” or “daughtercards”, may be connected through the backplane.

A known backplane is a PCB onto which many connectors may be mounted. Conducting traces in the backplane may be electrically connected to signal conductors in the connectors so that signals may be routed between the connectors. Signals may be routed among daughtercards through the connectors and the backplane. For example, daughtercards may also have connectors mounted thereon. The connectors mounted on a daughtercard may be plugged into the connectors mounted on the backplane.

Electrical connector designs have been adapted to mirror trends in the electronic industry. Electronic systems have generally become smaller, faster and more complex in functions. These changes mean that the number of circuits in a given area of an electronic system, along with the frequencies at which the circuits operate have increased significantly in recent years. Current systems pass more data between the printed circuit boards and requires electrical connectors which can electrically process more data at a higher speed than the electrical connectors of even a few years ago.

Card edge connectors may be used to connect daughtercards, sometimes referred to as add-in cards, to a backplane, such that the storage and/or function abilities of the backplane may be expanded by the daughtercards.

### SUMMARY

Aspects of the present disclosure relate to high density hybrid electrical connectors that can transmit signals and power simultaneously.

Some embodiments relate to an electrical connector. The electrical connector may include a housing comprising a mating face and a slot recessed into the mating face; a plurality of power conductive elements held by the housing, each of the plurality of power conductive elements comprising a mating end having a plurality of contact fingers, a mounting end having a plurality of mounting tails, and an intermediate portion between the mating end and the mounting end, each of the plurality of contact fingers comprising a contact region disposed in the slot; and a plurality of signal conductive elements, each of the plurality of signal conductive elements comprising a mating end having a mating contact portion disposed in the slot, a mounting end, and an intermediate portion between the mating end and the mounting end. The plurality of power conductive elements may comprise first, second, and third power conductive elements, the second power conductive element disposed between the first and third power conductive elements. The second power conductive element may be spaced from the first power conductive element by a first center-to-center spacing. The second power conductive element may be spaced from the third power conductive element by a second center-to-center pitch less than the first center-to-center spacing. Adjacent signal conductive elements of the plurality of signal conductive elements may be spaced from each other by a third center-to-center pitch less than the first center-to-center spacing.

Optionally, the first power conductive element is configured for transmitting a first voltage; each of the second and third power conductive elements are configured for transmitting a second voltage; and the first voltage is a multiple of the second voltage.

Optionally, the plurality of power conductive elements comprises fourth and fifth power conductive elements each configured for transmitting the second voltage; and the first voltage is 48V and the second voltage is 12V.

Optionally, each of the plurality of power conductive elements is configured to carry a current of 30 amperes with a temperature rise in a range of 0 to 30 degrees.

Optionally, the fourth power conductive element is disposed between the third and fifth conductive elements and spaced from the third and fifth power conductive elements by the second center-to-center pitch; the first center-to-center spacing is 9.1 mm; and the second center-to-center pitch is 8.5 mm.

Optionally, the plurality of mounting tails of the mounting end of each of the plurality of power conductive elements are configured for inserting into a circuit board; and the mounting end of each of the plurality of signal conductive elements is configured for surface mount to the circuit board.

Optionally, the third center-to-center pitch is 0.65 mm.

Optionally, the housing comprises a first rib disposed between the first and second conductive elements of the plurality of power conductive elements; a second rib disposed between the second and third conductive elements of the plurality of power conductive elements, the second rib narrower than the first rib in a direction the slot of the housing elongated; and a third rib disposed between the plurality of signal conductive elements and the first conductive element of the plurality of power conductive elements, the third rib wider than the first rib in the direction the slot of the housing elongated.

Optionally, the housing comprises a projection extending from a bottom of the housing into the slot and disposed between the plurality of signal conductive elements and the first conductive element of the plurality of power conductive elements.

Some embodiments relate to an electrical connector. The electrical connector may include a housing comprising a mating face and a slot recessed into the mating face; a plurality of conductive elements held by the housing and disposed in two rows on opposite sides of the slot, each of the two rows of conductive elements comprising a plurality of signal terminals and a plurality of power terminals. For each of the two rows: the plurality of power terminals may comprise a first power terminal and a number of second power terminals, wherein the number is at least two; the first power terminal may be spaced edge-to-edge from an adjacent second power terminal of the number of second power terminals by a first distance; adjacent second power terminals of the number of second power terminals may be spaced edge-to-edge from each other by a second distance less than the first distance in a direction the slot elongated; and the first power terminal may be disposed between the plurality of signal terminals and the number of second power terminals and spaced edge-to-edge from the plurality of signal terminals by a third distance greater than the first distance in the direction the slot elongated.

Optionally, the first power terminal is configured for transmitting a first voltage; each of the number of second power terminals is configured for transmitting a second voltage; and the first voltage is equal to the second voltage multiplied by the number.

Optionally, the two rows of conductive elements have mating contact portions disposed in the slot.

Optionally, the first power terminal and the number of second power terminals in one of the two rows are configured for positive electrodes; and the first power terminal and the number of second power terminals in the other of the two rows are configured for negative electrodes.

Optionally, the housing comprises, on each side of the opposite sides of the slot, a first accommodating portion and a plurality of second accommodating portions recessed into a side wall of the housing from the slot; and for each of the two rows of the conductive elements: each power terminal of the first power terminal and the number of second power terminals comprises a mating end having a mating contact portion; the mating end of the first power terminal is disposed in the first accommodating portion such that the mating contact portion of the mating end of the first power terminal extends into the slot; and the mating end of each of the number of second power terminals is disposed in a corresponding second accommodating portion of the plurality of second accommodating portions such that the mating contact portion of the mating end of the second power terminal extends into the slot.

Optionally, the side wall of the housing comprises a plurality of holes extending therethrough.

Optionally, the housing comprises, on each side of the opposite sides of the slot: a first rib disposed between the first accommodating portion and an adjacent second accommodating portion of the plurality of second accommodating portions; a plurality of second ribs each disposed between adjacent second accommodating portions of the plurality of second accommodating portions; and each of the plurality of second ribs is narrower than the first rib in a direction the slot elongated.

Optionally, for each of the two rows: each of the plurality of power terminals comprises a mating end having a plurality of contact fingers, a mounting end having a plurality of mounting tails, and an intermediate portion between the mating end and the mounting end; each of the plurality of contact fingers comprises a straight portion, a curved portion, and a contact portion; the straight portion extends from the intermediate portion towards the mating face; the curved portion connects the straight portion and the contact portion; and the contact portion extends from the curved portion away from the mating face and comprises a contact region extending into the slot.

Optionally, the plurality of mounting tails are at least four mounting tails; and the plurality of contact fingers are at least eight contact fingers.

Some embodiment relates to an electronic system. The electronic system may include an electrical connector a housing comprising a mating face and a slot recessed into the mating face, and a plurality of conductive elements held by the housing and each comprising a mating contact portion disposed in the slot and a mounting end extending out of the housing; a first circuit board comprising a mating portion inserted into a slot of the electrical connector and first circuitry connected to the mating portion and configured to regulate a first voltage to a second voltage different from the first voltage, the mating portion of the first circuit board comprising a plurality of contact pads contacting respective mating contact portions of the plurality of conductive elements; and a second circuit board comprising a plurality of conductive portions contacting respective mounting ends of the plurality of conductive elements and second circuitry supplying the first voltage, the second circuitry connected to at least a conductive portion of the plurality of conductive portions. The plurality of conductive elements of the electrical connector may include a plurality of signal terminals and a plurality of power terminals. The plurality of power terminals of the electrical connector may comprise a first power terminal connected to the at least a conductive portion connected to the second circuitry supplying the first voltage and a plurality of second power terminals each configured for transmitting the second voltage.

Optionally, the plurality of signal terminals of the electrical connector comprise mounting ends for surface mount to the second circuit board; and the plurality of power terminals of the electrical connector comprise mounting ends for inserting into the second circuit board.

Some embodiments relate to an electrical connector. The electrical connector may include an insulative housing comprising a first face, a first slot portion, and a second slot portion, the first slot portion and the second slot portion recessed into the insulative housing from the first face in a vertical direction, respectively, and separated from each other in a longitudinal direction perpendicular to the vertical direction by a projection of the insulative housing; a plurality of signal terminals held in the insulative housing such that mating contact portions of the plurality of signal terminals extend into the first slot portion; and a plurality of power terminals held in the insulative housing such that mating contact portions of the plurality of power terminals extend into the second slot portion. The plurality of power terminals may include a first group of power terminals configured for transmitting a first voltage, the first group of power terminals closer to the projection in the longitudinal direction than the remaining power terminals of the plurality of power terminals; and a second group of power terminals disposed adjacent to the first group of power terminals and configured for transmitting a second voltage, the first voltage being greater than the second voltage.

Optionally, the first group of power terminals comprises a first number of power terminals, and the second group of power terminals comprises a second number of power terminals, and the first number is less than the second number.

Optionally, the first voltage is N times greater than the second voltage, and the first number is one Nth of the second number, wherein N is an integer greater than 1.

Optionally, the first group of power terminals is a pair of first power terminals, the pair of first power terminals are disposed facing each other and spaced apart from each other across the second slot portion in a lateral direction perpendicular to the vertical direction and the longitudinal direction, the second group of power terminals is a plurality of pairs of second power terminals, each pair of the plurality of pairs of second power terminals are disposed facing each other and spaced apart from each other across the second slot portion in the lateral direction.

Optionally, the first group of power terminals and the second group of power terminals are arranged in two power terminal rows disposed facing each other and spaced apart from each other across the second slot portion in the lateral direction, the power terminals of each power terminal row are aligned with each other and spaced apart from each other in the longitudinal direction.

Optionally, for each power terminal row, the mating contact portion of the first power terminal and the mating contact portion of a corresponding adjacent second power terminal are spaced center-to-center from each other in the longitudinal direction by a first spacing, the mating contact portions of every two adjacent second power terminals are spaced center-to-center from each other in the longitudinal direction by a second pitch, and the first spacing is greater than the second pitch.

Optionally, the mating contact portion of the first power terminal has a first width in the longitudinal direction, and the mating contact portion of the second power terminal has a second width in the longitudinal direction, and the first width is equal to the second width.

Optionally, the first spacing is 9.1 mm and the second pitch is 8.5 mm.

Optionally, for each power terminal row, the mating contact portion of the first power terminal and the mating contact portion of the corresponding adjacent second power terminal are spaced edge-to-edge from each other in the longitudinal direction by a third pitch, the mating contact portions of every two adjacent second power terminals are spaced edge-to-edge from each other in the longitudinal direction by a fourth pitch, and the third pitch is greater than the fourth pitch.

Optionally, the plurality of pairs of second power terminals are four pairs of second power terminals.

Optionally, each power terminal of the pair of first power terminals and the plurality of pairs of second power terminals is configured to be capable of carrying a current of 30 amperes with a temperature rise of no more than 30 degrees Celsius.

Optionally, the first voltage is 48V and the second voltage is 12V.

Optionally, each of the first power terminal and the second power terminals of one of the two power terminal rows is configured to be used as a positive electrode, and each of the first power terminal and the second power terminals of the other power terminal row is configured to be used as a negative electrode.

Optionally, the insulative housing comprises a pair of first accommodating portions and a plurality of pairs of second accommodating portions recessed into the insulative housing from the second slot portion in the lateral direction, respectively, each power terminal of the pair of first power terminals and the plurality of pairs of second power terminals comprises a mating end having a mating contact portion, the mating end of each first power terminal is disposed in a corresponding first accommodating portion of the pair of first accommodating portions such that the mating contact portion of the mating end of the first power terminal extends into the second slot portion, and the mating end of each second power terminal is disposed in a corresponding second accommodating portion of the plurality of pairs of second accommodating portions such that the mating contact portion of the mating end of the second power terminal extends into the second slot portion, and every two adjacent ones of the first accommodating portions and the second accommodations portion are separated from each other in the longitudinal direction by a rib of the insulative housing.

Optionally, each first accommodating portion and a corresponding adjacent second accommodating portion are separated from each other in the longitudinal direction by a first rib of the ribs, and the first rib has a third width in the longitudinal direction, every two adjacent second accommodating portions are separated from each other in the longitudinal direction by a second rib of the ribs, and the second rib has a fourth width in the longitudinal direction, and the third width is greater than the fourth width.

Optionally, the insulative housing further comprises a plurality of mounting grooves each recessed into the insulative housing from a corresponding one of the first accommodating portions and the second accommodating portions away from the first face in the vertical direction, each power terminal of the pair of first power terminals and the plurality of pairs of second power terminals comprises an intermediate portion mounted in a corresponding one of the plurality of mounting grooves, and a plurality of contact fingers extending from the intermediate portion towards the first face and spaced apart from each other in the longitudinal direction, the plurality of contact fingers together form the mating end of the power terminals.

Optionally, the electrical connector is configured for establishing a separable electrical connection to a first circuit board, the first circuit board comprises a mating portion configured for insertion into the second slot portion of the insulative housing, the mating portion comprises a first surface and a second surface opposite to the first surface, the first surface and the second surface each have a plurality of conductive regions, when the mating portion is inserted into the second slot portion, the mating portion is positioned between the two power terminal rows, and for each power terminal row, the mating contact portion of each of the first power terminal and the second power terminal electrical contacts a corresponding one of the plurality of conductive regions of the mating portion.

Optionally, each of the plurality of contact fingers comprises a straight portion, a curved portion, and a contact portion, the straight portion extends from the intermediate portion towards the first face, the curved portion connects the straight portion and the contact portion, the contact portion extends from the curved portion away from the first face and includes a contact region extending into the second slot portion, the contact regions of the contact portions of the plurality of contact fingers together form the mating contact portion of the mating end of the power terminal.

Optionally, the insulative housing further comprises a second face opposite to the first face in the vertical direction, each of the plurality of mounting grooves extends through the insulative housing to the second surface in the vertical direction, each power terminal of the pair of first power terminals and the plurality of pairs of second power terminals further comprises a plurality of mounting tails extending from the intermediate portion oppositely to the plurality of contact fingers and spaced apart from each other in the longitudinal direction, the plurality of mounting tails extend through a corresponding one of the plurality of mounting grooves and beyond the second face.

Optionally, the plurality of mounting tails comprise at least four mounting tails.

Optionally, the plurality of contact fingers comprise at least eight contact fingers.

Optionally, the insulative housing comprises heat emission holes each communicating each of the first accommodating portions and the second accommodating portions with an outer side wall of the insulative housing in the lateral direction.

Optionally, the first power terminals and the second power terminals have the same configurations.

Optionally, there is only one first slot portion and only one second slot portion.

Optionally, the first slot portion and the second slot portion are disposed asymmetrically about a centerline of the insulative housing in the longitudinal direction.

Optionally, the plurality of signal terminals are arranged in two signal terminal rows disposed facing each other and spaced apart from each other across the first slot portion in a lateral direction perpendicular to the vertical direction and the longitudinal direction, the signal terminals of each signal terminal row are aligned with each other and spaced apart from each other in the longitudinal direction.

Some embodiments relate to an electronic system. The electronic system may include the aforementioned electrical connector; a first circuit board comprising a first mating portion and a second mating portion, the first mating portion configured for insertion into the first slot portion of the electrical connector and having a first conductive portion, the second mating portion configured for insertion into the second slot portion of the electrical connector and having a second conductive portion and a third conductive portion; and a second circuit board having a first conductive portion, a second conductive portion, and a third conductive portion. The electrical connector is mounted to the second circuit board, and the first mating portion and the second mating portion of the first circuit board are inserted into the first slot portion and the second slot portion of the electrical connector, respectively, such that: the plurality of signal terminals interconnect the first conductive portion of the first circuit board and the first conductive portion of the second circuit board to transmit signals therebetween; the first group of power terminals interconnect the second conductive portion of the first circuit board and the second conductive portion of the second circuit board to transmit the first voltage therebetween; and the second group of power terminals interconnect the third conductive portion of the first circuit board and the third conductive portion of the second circuit board to transmit the second voltage therebetween.

Optionally, the first circuit board is a voltage regulator module.

These techniques may be used alone or in any suitable combination. The foregoing summary is provided by way of illustration and is not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a perspective view of an electronic system including an electrical connector connecting a first circuit board and a second circuit board each shown partially cut away, according to some embodiments of the present application;

FIG. 2 is an exploded view of the electronic system shown in FIG. 1;

FIG. 3A is a perspective view of the first circuit board shown in FIG. 1, showing one side of the first circuit board;

FIG. 3B is another perspective view of the first circuit board shown in FIG. 3A, showing the other side of the first circuit board;

FIG. 3C is a perspective view of the second circuit board shown in FIG. 1;

FIG. 4 is an exploded view of the electrical connector shown in FIG. 1;

FIG. 5A is a top, front perspective view of the electrical connector shown in FIGS. 1 and 4;

FIG. 5B is a bottom, front perspective view of the electrical connector shown in FIG. 5A;

FIG. 5C is a bottom, side perspective view of the electrical connector shown in FIG. 5A;

FIG. 5D is a top view of the electrical connector shown in FIG. 5A;

FIG. 5E is a bottom view of the electrical connector shown in FIG. 5A;

FIG. 5F is a front view of the electrical connector shown in FIG. 5A;

FIG. 5G is a cross-sectional perspective view of the electrical connector shown in FIG. 5A taken along line I-I in FIG. 5D;

FIG. 5H is a cross-sectional perspective view of the electrical connector shown in FIG. 5A taken along line II-II in FIG. 5D;

FIG. 5I is a cross-sectional perspective view of the electrical connector shown in FIG. 5A taken along line III-III in FIG. 5D;

FIG. 6A is a top, side perspective view of an insulative housing of the electrical connector shown in FIG. 5A;

FIG. 6B is a bottom, front perspective view of the insulative housing shown in FIG. 6A;

FIG. 6C is a top, front perspective view of the insulative housing shown in FIG. 6A;

FIG. 6D is a top view of the insulative housing shown in FIG. 6A;

FIG. 6E is a bottom view of the insulative housing shown in FIG. 6A;

FIG. 7 is a top view of the electrical connector shown in FIG. 5A, with the insulative housing of the electrical connector hidden, showing conductive terminals in the insulative housing;

FIG. 8A is a front perspective view of a first power terminal of a first group of power terminals of the electrical connector shown in FIG. 5A;

FIG. 8B is a front, side perspective view of the first power terminal shown in FIG. 8A;

FIG. 8C is a rear, side perspective view of the first power terminal shown in FIG. 8A;

FIG. 8D is a front view of the first power terminal shown in FIG. 8A;

FIG. 8E is a rear view of the first power terminal shown in FIG. 8A;

FIG. 8F is a side view of the first power terminal shown in FIG. 8A;

FIG. 9A is a front, side perspective view of one of a plurality of signal terminals of the electrical connector shown in FIG. 5A, showing a first side;

FIG. 9B is another front, side perspective view of the signal terminal shown in FIG. 9A, showing a second side opposite to the first side; and

FIG. 9C is a side view of the signal terminal shown in FIG. 9A.

### LIST OF REFERENCE NUMERALS

| | |
|---|---|
| X-X | lateral direction |
| Y-Y | longitudinal direction |
| Z-Z | vertical direction |
| 1 | electronic system |
| 3 | first circuit board |
| 3a | first end portion of the first circuit board |
| 3b | notch of the first circuit board |
| 3c | edge of the first end portion of the first circuit board |
| 31 | first mating portion |
| 31a | first surface of the first mating portion |
| 31b | second surface of the first mating portion |
| 31c | first conductive portion |
| 31d | conductive pad |
| 33 | second mating portion |
| 33a | first surface of the second mating portion |
| 33b | second surface of the second mating portion |
| 33c | second conductive portion |
| 33d | third conductive portion |
| 33e | first conductive region |
| 33f | second conductive region |
| 5 | second circuit board |
| 5a | first surface of the second circuit board |
| 5b | second surface of the second circuit board |
| 51 | first conductive portion |
| 51a | conductive pad |
| 52 | second conductive portion |
| 52a | first conductive through hole |
| 53 | third conductive portion |
| 53a | second conductive through hole |
| 10 | electrical connector |
| 100 | insulative housing |
| 100a | first face of the insulative housing |
| 100b | second face of the insulative housing |
| 101 | first slot portion |
| 102 | second slot portion |
| 103 | projection |
| 104 | terminal slot |
| 110 | first accommodating portion |
| 120 | second accommodating portion |
| 130 | first mounting groove |
| 140 | second mounting groove |
| 151 | first rib |
| 152 | second rib |
| 153 | third rib |
| 160 | heat emission hole |
| 200 | signal terminal |
| 201 | mating end of the signal terminal |
| 201a | mating contact portion of the mating end of the signal terminal |
| 202 | mounting end of the signal terminal |
| 203 | intermediate portion of the signal terminal |
| 300A | first group of power terminals |
| 310 | first power terminal |
| 311 | mating end of first power terminal |
| 311a | mating contact portion of the mating end of the first power terminal |
| 312 | mounting end of the first power terminal |
| 3121 | mounting tail of the mounting end of the first power terminal |
| 313 | intermediate portion of the first power terminal |
| 3111 | contact finger |
| 3112 | straight portion |
| 3113 | curved portion |
| 3114 | contact portion |
| 3114a | contact region |
| 300B | second group of power terminals |
| 320 | second power terminal |
| 321 | mating end of the second power terminal |
| 321a | mating contact portion of the mating end of the second power terminal |
| 322 | mounting end of the second power terminal |
| 3221 | mounting tail of the mounting end of the second power terminal |
| 323 | intermediate portion of the second power terminal |
| R1 | power terminal row |
| R2 | power terminal row. |

### DETAILED DESCRIPTION

The inventors have recognized and appreciated electrical design techniques for making high density hybrid card edge connector that can provide both high quality signal transmission and high power transmission. Techniques described herein can enable integrating both a signal transmission section and multiple power transmission sections into one electrical connector, without arcing between different power levels of the power transmission sections. The conductive terminals in the electrical connector can be arranged in high density, while providing both high quality signals at high speed and the ability to pass high power. The connector can have a footprint that fits in a limited space close to a voltage source on the board. The power transmission sections of the electrical connector may include at least two sections for transmitting power at the first voltage and the second voltage, respectively. The connector may be configured to connect a voltage regulator module to the voltage source on the board such that the first voltage can be regulated to the second voltage more efficiently with less loss.

According to aspects of the present application, an electrical connector may include a housing having a mating face and a slot recessed into the mating face, and conductive elements held by the housing in two rows on opposite sides of the slot. Each conductive element may have a mating end with a mating contact portion disposed in the slot of the housing, a mounting end extending out of the housing, and an intermediate portion between the mating end and the mounting end. The electrical connector can be mounted to a board and can receive a card in the slot so as to interconnect the card to the board.

For each of the two rows, the conductive elements may include both signal conductive elements and power conductive elements. The signal and power conductive elements may have different types of mounting ends. For example, the signal conductive elements may have mounting ends configured for surface mount on a circuit board so as to transmit signals at high speed, while the power conductive elements may have mounting ends configured for inserting into the circuit board so as to carry high power. The power conductive elements may include a first power conductive element disposed between the signal conductive elements and a number of second conductive elements, wherein the number is at least two. The first power conductive element may be spaced from the second conductive elements by a first center-to-center spacing. Adjacent second conductive elements may be spaced from each other by a second center-to-center pitch less than the first center-to-center spacing. The first power conductive element may be spaced from the signal conductive elements by a third center-to-center pitch greater than the first center-to-center spacing. The power conductive elements in one of the two rows may be configured for positive electrodes; and the power conductive element in the other one of the two rows may be configured for negative electrodes.

In some embodiments, the first power conductive element may be configured for transmitting a first voltage. Each of the second power conductive elements may be configured for transmitting a second voltage. The first voltage may be higher than the second voltage and, in some examples, may be a multiple of the second voltage. For example, the first voltage may be the second voltage multiplied by the number. For example, there may be one first power conductive element and four second power conductive elements; and the first voltage may be 48 V and the second voltage may be 12 V.

In some embodiments, the housing may include a first rib disposed between the first power conductive element and the second power conductive elements, a second rib disposed between adjacent power conductive elements, and a third rib disposed between the first power conductive element and the signal conductive elements. The first rib may be wider than the second rib in the row direction, and narrower than the third rib in the row direction. The housing may include a projection extending from a bottom into slot and disposed between the first power conductive element and the signal conductive elements.

According to aspects of the present application, an insulative connector housing may have a first slot portion and a second slot portion, separated from each other in a longitudinal direction by a projection. A plurality of signal terminals may be held in the insulative housing such that mating contact portions of the signal terminals extend into the first slot portion. A plurality of power terminals may be held in the insulative housing such that mating contact portions of the power terminals extend into the second slot portion. The plurality of power terminals may include a first group of power terminals configured for transmitting a first voltage, and a second group of power terminals disposed adjacent to the first group of power terminals and configured for transmitting a second voltage. The first group of power terminals may be disposed closer to the projection in the longitudinal direction than the remaining power terminals of the plurality of power terminals. The first voltage may be greater than the second voltage. The first group of power terminals may be configured to carry a smaller current less than the second group of power terminals. Disposing the first group of power terminals to be closer to the projection of the insulative housing and closer to the plurality of signal terminals than the second group of power terminals can increase the creepage distance at the region adjacent to the projection and the signal terminals. Such a configuration can provide better heat dissipation performance and reduce interference with the signals transmitted by the signal terminals so as to enable disposing the conductive elements in high density, thereby facilitating miniaturization of the electrical connector.

Some embodiments of the present application are described in detail below in conjunction with the accompanying drawings. It should be appreciated that these embodiments are not intended to limit the present application.

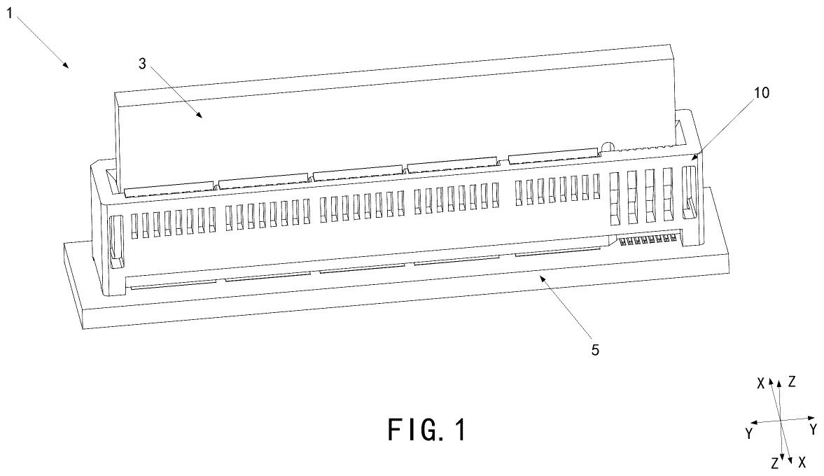

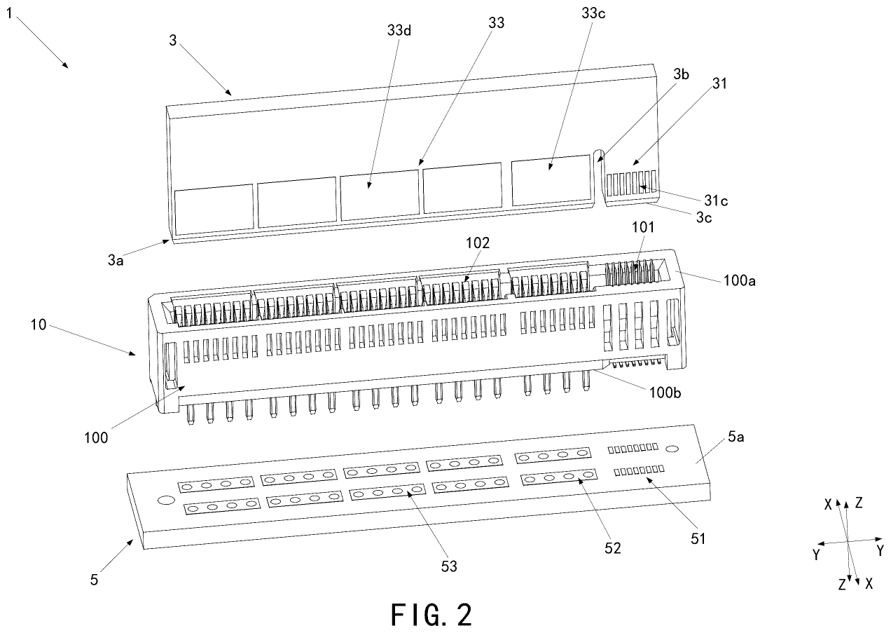

FIGS. 1 and 2 illustrate an electronic system 1, which may include a first circuit board 3, a second circuit board 5, and an electrical connector 10, according to some embodiments of the present application.

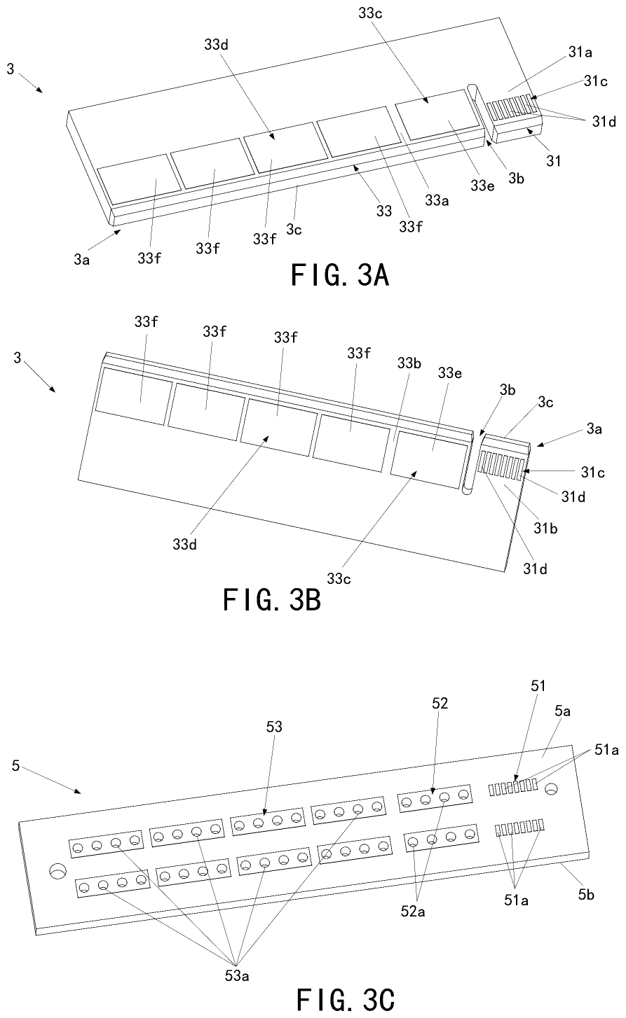

The first circuit board 3 may also be referred to as “a first printed circuit board” or “a first PCB”, which may be, for example, a daughter card such as a voltage regulator common module (VRCM). FIGS. 3A and 3B illustrate an exemplary version of the first circuit board 3. It should be appreciated that the illustrated first circuit board 3 may include a portion of the first circuit board 3 configured for mating with the electrical connector 10. It should be appreciated that the first circuit board 3 is not intended to be limited in this aspect.

As shown in FIGS. 3A and 3B, the first end portion 3a of the first circuit board 3 may be configured for insertion into a slot of the electrical connector 10. A notch 3b may be recessed into the first circuit board 3 from an edge 3c at the first end portion 3a to separate the first end portion 3a into a first mating portion 31 and a second mating portion 33. The first mating portion 31 and the second mating portion 33 may be configured for insertion into a corresponding slot of the electrical connector 10, as will be described in detail below. The first mating portion 31 may include a first surface 31a and a second surface 31b opposite to each other. The first mating portion 31 may include a first conductive portion 31c including a plurality of conductive pads 31d disposed on the first surface 31a and the second surface 31b. On each of the first surface 31a and the second surface 31b, the conductive pads 31d are disposed spaced apart from each other by a certain pitch. The second mating portion 33 may include a first surface 33a and a second surface 33b opposite to each other. The second mating portion 33 may include a second conductive portion 33c and a third conductive portion 33d. The second conductive portion 33c may include a plurality of first conductive regions 33e disposed on the first surface 33a and the second surface 33b, and the third conductive portion 33d may include a plurality of second conductive regions 33f disposed on the first surface 33a and the second surface 33b. On each of the first surface 33a and the second surface 33b, the first conductive regions 33e and the second conductive regions 33f are spaced apart from each other by a certain pitch. As will be described in detail below, the conductive pads 31d, the first conductive regions 33c, and the second conductive regions 33f may establish electrical connections with the electrical connector 10.

The second circuit board 5 may also be referred to as “a second printed circuit board” or “a second PCB”, which may be, for example, a motherboard, such as a server motherboard. FIG. 3C illustrates an exemplary version of the second circuit board 5. It should be appreciated that the illustrated second circuit board 5 may include a portion of the second circuit board 5 configured for mating with the electrical connector 10. It should be appreciated that the second circuit board 5 is not intended to be limited in this aspect. The second circuit board 5 may include, for example, a portion having a circuit that provides a first voltage V1, which may be regulated to a second voltage V2 by a circuit of the first circuit board 3.

As shown in FIG. 3C, the second circuit board 5 may include a first surface 5a and a second surface 5b opposite to each other. The second circuit board 5 may also include a first conductive portion 51, a second conductive portion 52, and a third conductive portion 53 disposed on the first surface 5a. The first conductive portion 51 may include a plurality of conductive pads 51a arranged in two rows spaced apart from each other. The second conductive portion 52 may comprise a plurality of groups of first conductive through holes 52a, and the third conductive portion 53 may comprise a plurality of groups of second conductive through holes 53a. As will be described in detail below, the first conductive portion 51, the second conductive portion 52, and the third conductive portion 53 may establish electrical connections with the electrical connector 10.

As shown in FIG. 1 and as will be described in detail below, the electrical connector 10 may be used to establish a separable electrical connection to the first circuit board 3 so as to mechanically and electrically connect the first circuit board 3 to the second circuit board 5. For example, the electrical connector 10 may be mounted to the second circuit board 5 and the first mating portion 31 and the second mating portion 33 of the first circuit board 3 may be inserted into the corresponding slots of the electrical connector 10, respectively, so as to establish electrical connections between the first conductive portion 31c, the second conductive portion 33c, and the third conductive portion 33d of the first circuit board 3 and the first conductive portion 51, the second conductive portion 52, and the third conductive portion 53 of the second circuit board 5 through the conductive terminals of the electrical connector 10 to transmit signals and power between the first circuit board 3 and the second circuit board 5. The electrical connector 10 may be referred to as “a card edge connector.”

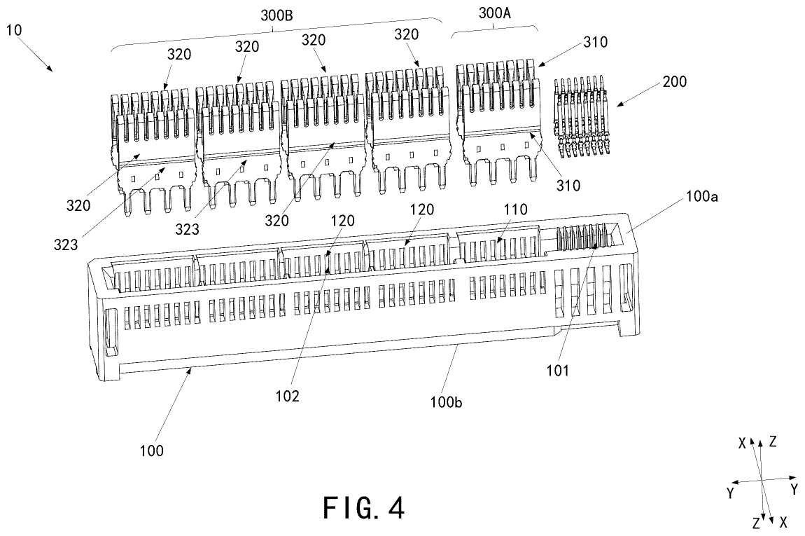

The electrical connector 10 is illustrated in detail in FIGS. 4 to 9C. For the sake of clarity and conciseness of description, a lateral direction X-X, a longitudinal direction Y-Y, and a vertical direction Z-Z may be defined. The lateral direction X-X, the longitudinal direction Y-Y, and the vertical direction Z-Z may be perpendicular to each other. The lateral direction X-X may refer to a width direction of the electrical connector 10, the longitudinal direction Y-Y may refer to a length direction of the electrical connector 10, and the vertical direction Z-Z may refer to a height direction of the electrical connector 10.

As shown in FIG. 4, the electrical connector 10 may include an insulative housing 100 and a plurality of conductive terminals (or may be referred to as “conductive elements” or “conductors”) held in the insulative housing 100. The insulative housing 100 may be formed from an insulative material. Examples of insulative materials that are suitable for forming the insulative housing 100 include, but are not limited to, plastic, nylon, liquid crystal polymer (LCP), polyphenylene sulfide (PPS), high temperature nylon or polyphenylene oxide (PPO) or polypropylene (PP). Each of the plurality of conductive terminals may be formed from a conductive material. The conductive material suitable for forming the conductive terminals may be a metal or a metal alloy, such as a copper or a copper alloy.

As shown in FIGS. 4 to 6E, the insulative housing 100 of the electrical connector 10 may include a first face 100a and a second face 100b opposite to each other in the vertical direction Z-Z, and a first slot portion 101 and a second slot portion 102 each recessed into the insulative housing 100 from the first face 100a in the vertical direction Z-Z. The first face 100a may be referred to as “a mating face”, and the second face 100b may be referred to as “a mounting face.” The first slot portion 101 and the second slot portion 102 are each elongated in the longitudinal direction Y-Y perpendicular to the vertical direction Z-Z. The first slot portion 101 and the second slot portion 102 may be separated from each other in the longitudinal direction Y-Y by a projection 103 of the insulative housing 100. The projection 103 may be an integral portion of the insulative housing 100. As shown in FIGS. 1 and 2, the first slot portion 101 of the insulative housing 100 may be configured to receive the first mating portion 31 of the first circuit board 3, and the second slot portion 102 of the insulative housing 100 may be configured to receive the second mating portion 33 of the first circuit board 3. The projection 103 of the insulative housing 100 may be received in the notch 3b of the first circuit board 3 to guide the first mating portion 31 and the second mating portion 33 of the circuit board 3 into the first slot portion 101 and the second slot portion 102 of the insulative housing 100.

In some embodiments, there may be only one first slot portion 101 and only one second slot portion 102. In some embodiments, the first slot portion 101 and the second slot portion 102 may be disposed asymmetrically about a centerline of the insulative housing 100 in the longitudinal direction Y-Y. Such a configuration may provide a foolproof design. It should be appreciated that the present application is not intended to be limited in this aspect.

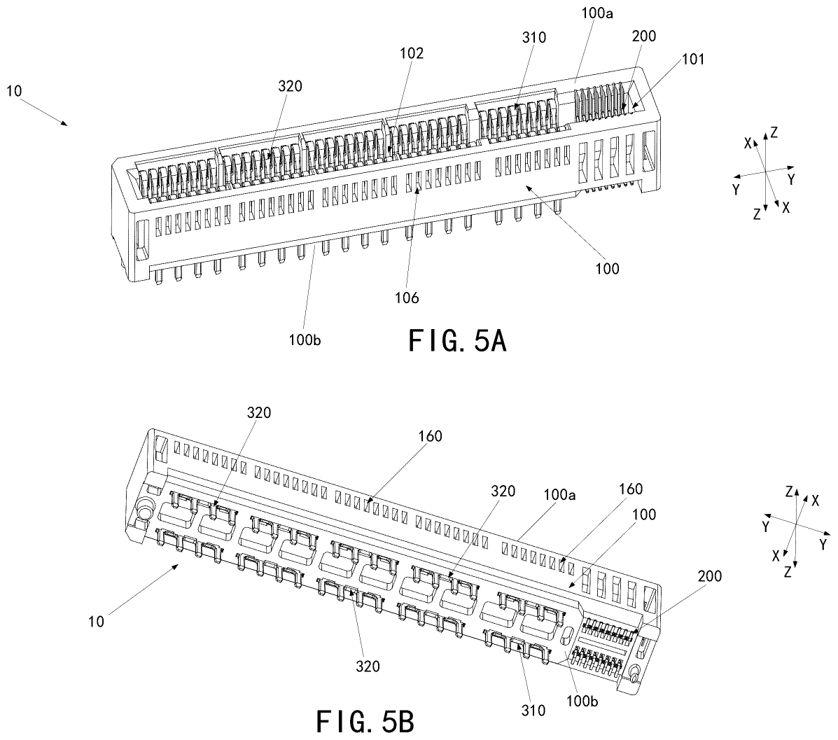

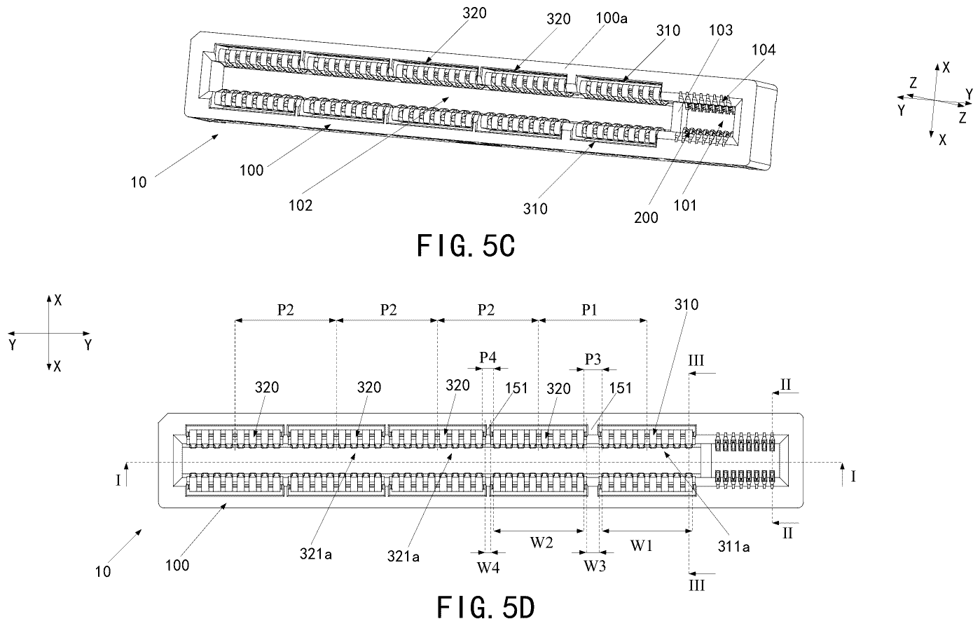

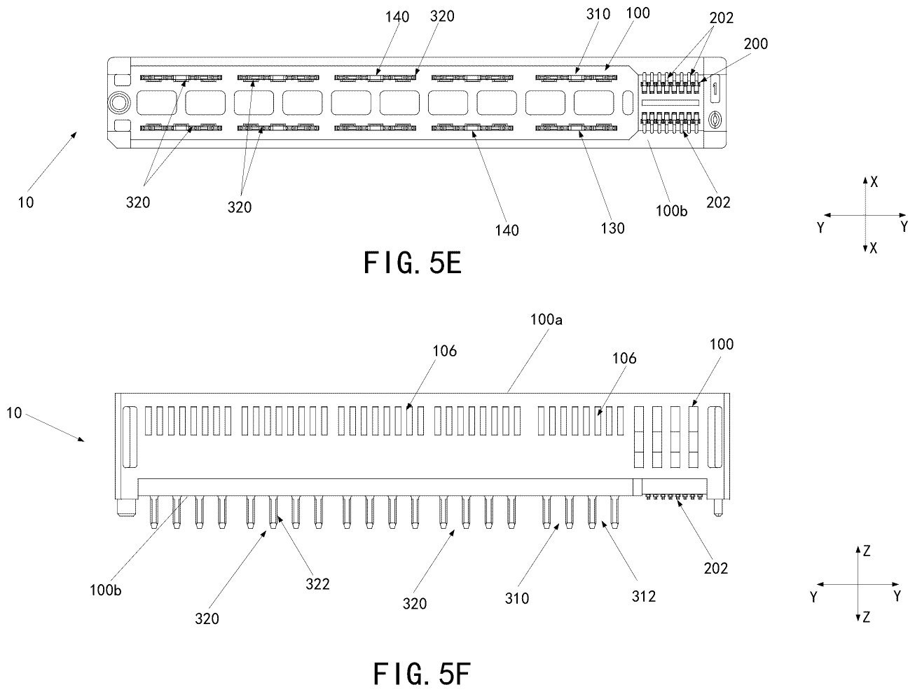

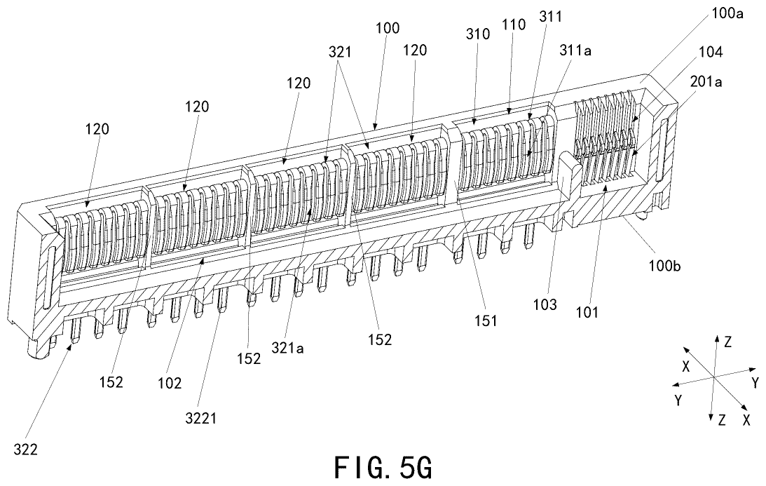

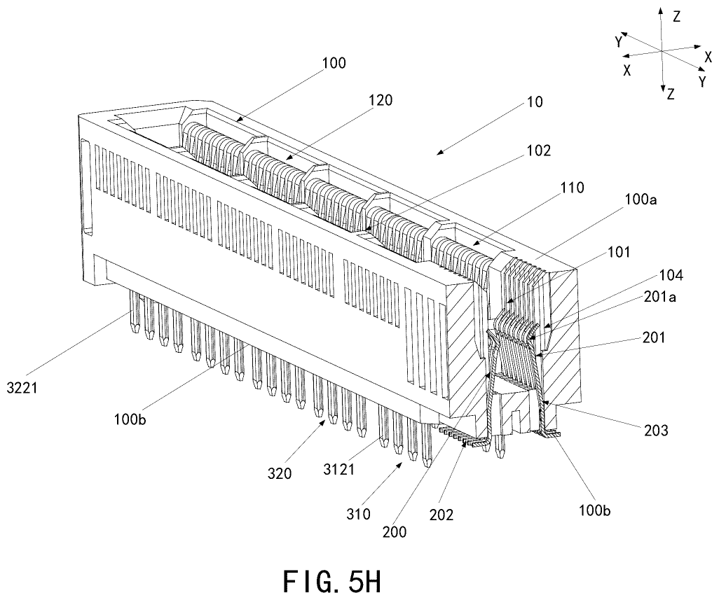

As shown in FIGS. 4 to 5I, the plurality of conductive terminals of the electrical connector 10 may include a plurality of signal terminals 200 disposed in the first slot portion 101 and a plurality of power terminals disposed in the second slot portion 102.

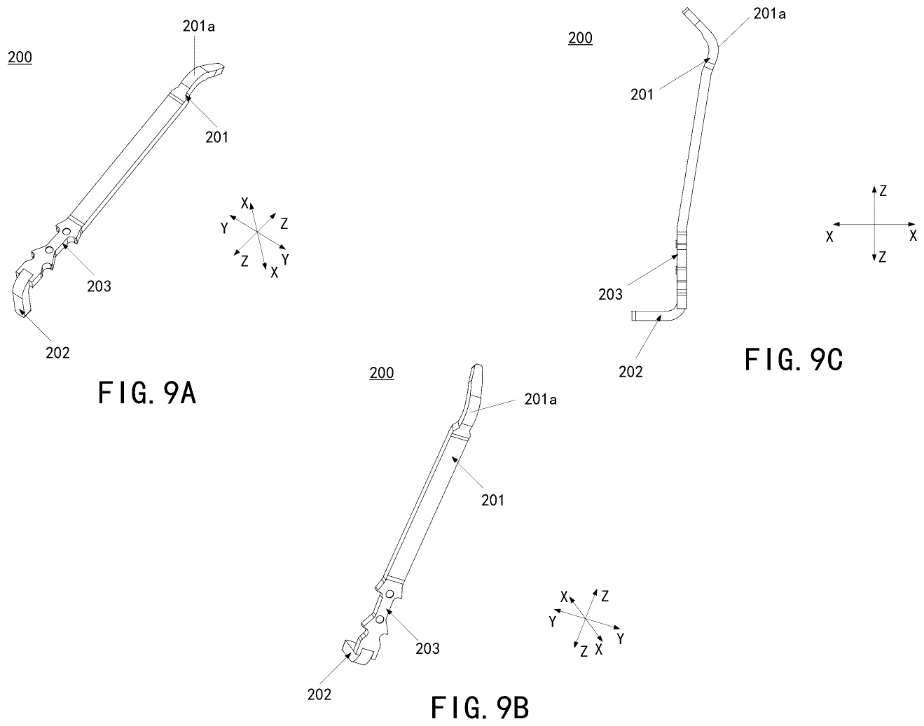

In some embodiments, the plurality of signal terminals 200 may have the same configurations. FIGS. 9A to 9C illustrate one of the plurality of signal terminals 200. The signal terminal 200 may include a mating end 201 having a mating contact portion 201a, a mounting end 202 opposite to the mating end 201, and an intermediate portion 203 connecting the mating end 201 and the mounting end 202. The mating end 201 may be configured for electrical contacting the conductive pad 31d of the first conductive portion 31c of the first mating portion 31 of the first circuit board 3. The mounting end 202 may be configured to be mounted to the conductive pad 51a of the first conductive portion 51 of the second circuit board 5. The mounting end 202 may be soldered to the conductive pad 51a by, for example, surface mount technology (SMT). It should be appreciated that in some other embodiments, the mounting end 202 may be in any other suitable form, such as a press fit “needle eye.” In this case, the conductive pads 51a of the first conductive portion 51 of the second circuit board 5 may be replaced by conductive through holes. The intermediate portion 203 of the signal terminal 200 may be configured for securing the signal terminal 200 in the insulative housing 100.

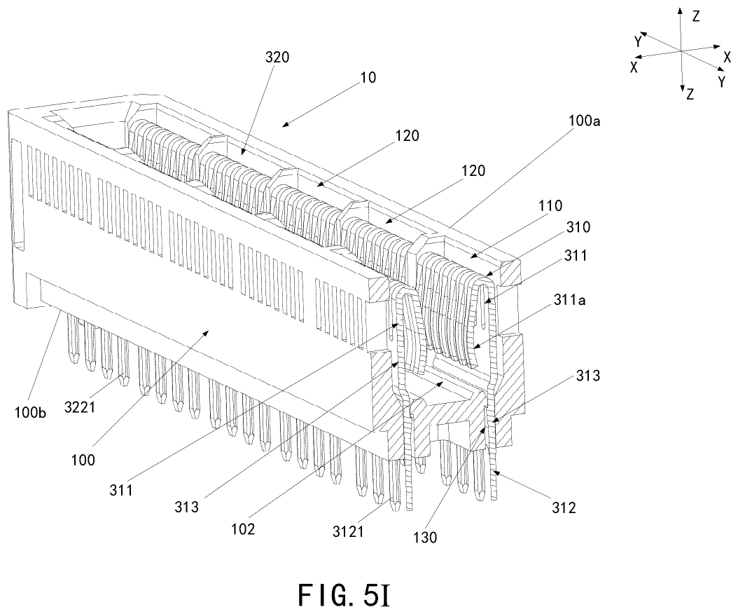

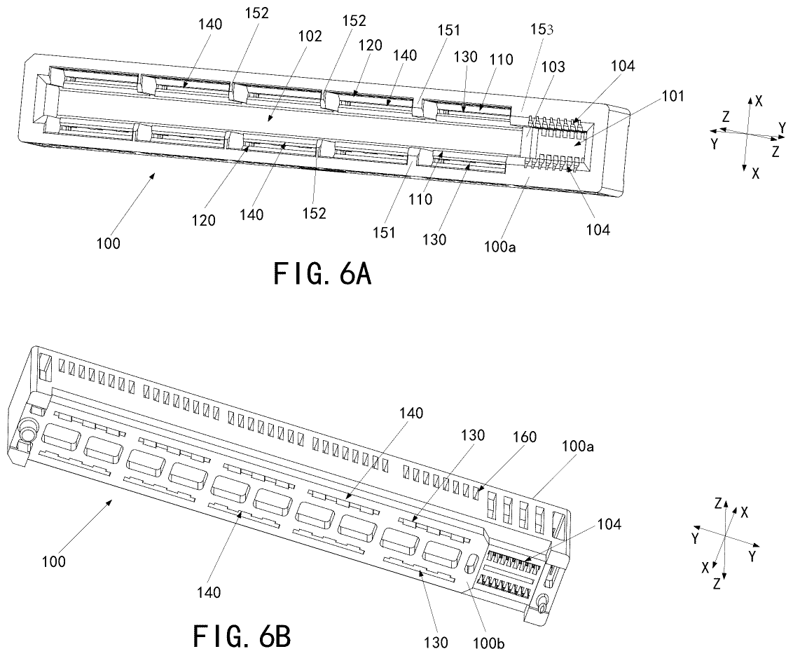

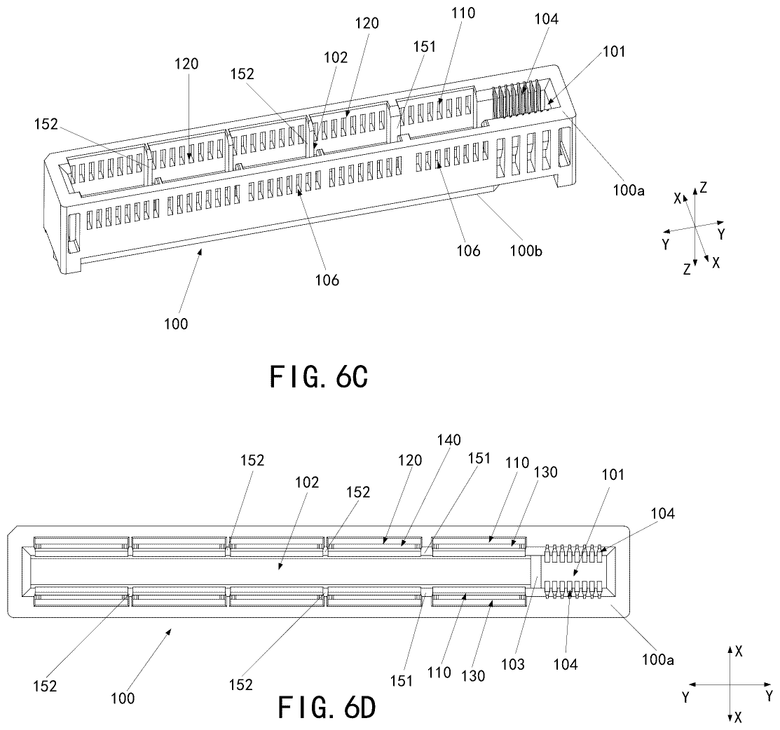

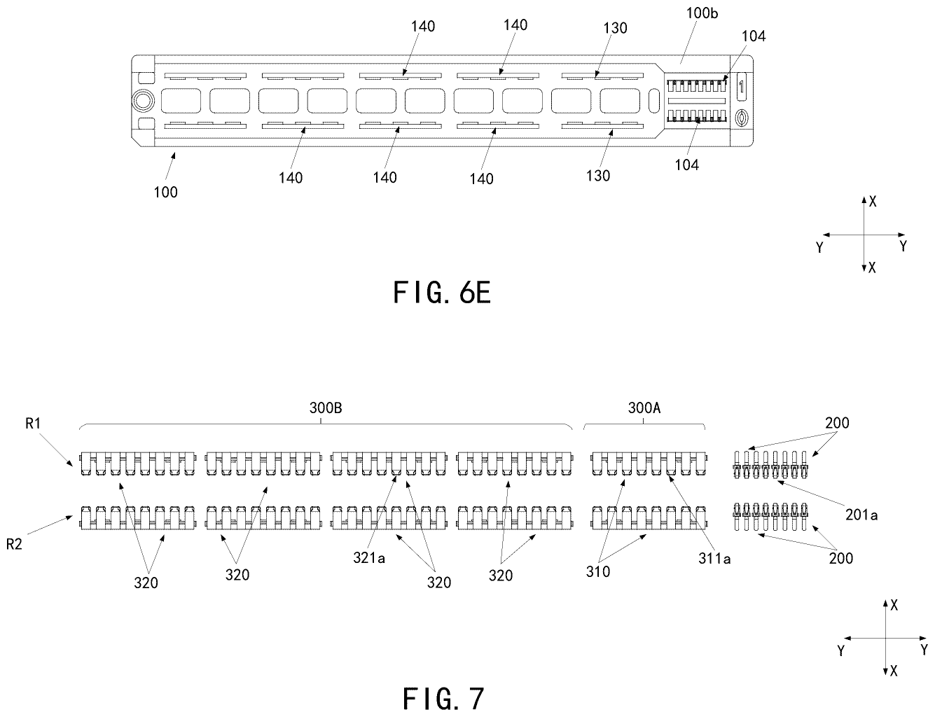

The plurality of signal terminals 200 may be held in the insulative housing 100 such that the mating contact portions 201a of the plurality of signal terminals 200 extend into the first slot portion 101 for mating with the first conductive portion 31c of the first mating portion 31 of the first circuit board 3. For example, as shown in FIGS. 5G to 6E, the insulative housing 100 of the electrical connector 10 may include a plurality of terminal slots 104 recessed into the insulative housing 100 from the first slot portion 101 in the lateral direction X-X perpendicular to the vertical direction Z-Z and the longitudinal direction Y-Y. As shown in FIGS. 5A to 5H, each of the plurality of signal terminals 200 is disposed in a corresponding one of the plurality of terminal slots 104. In some embodiments, the intermediate portion 203 of the signal terminal 200 may be configured to engage with an inner wall of the terminal slot 104 to secure the signal terminal 200 in the insulative housing 100. The mating contact portion 201a of the mating end 201 of the signal terminal 200 extends into the first slot portion 101. The intermediate portion 203 of the signal terminal 200 and/or the inner wall of the terminal slot 104 of the insulative housing 100 may be provided with structures that help retain the signal terminal 200 in the insulative housing 100. In some other embodiments, the plurality of signal terminals 200 may be held in the insulative housing 100 by any other suitable retention structure such as an insulative terminal retention member, or the insulative housing 100 may be overmolded over the plurality of signal terminals 200 to retain the signal terminals 200 in the insulative housing 100.

As shown in FIGS. 5C, 5D, and 7, the plurality of signal terminals 200 are arranged in two signal terminal rows disposed facing each other and spaced apart from each other in the lateral direction X-X across the first slot portion 101. The signal terminals 200 in each signal terminal row are aligned with each other and spaced apart from each other in the longitudinal direction Y-Y. The mating contact portions 201a of two adjacent signal terminals 200 in each signal terminal row may be spaced center-to-center from each other in the longitudinal direction Y-Y by a pitch of less than 0.80 mm. In some embodiments, the pitch may be between 0.60 mm and 0.70 mm. For example, the pitch may be 0.65 mm.

When the first mating portion 31 of the first circuit board 3 is inserted into the first slot portion 101 of the insulative housing 100 as shown in FIG. 1, the first mating portion 31 is disposed between the two signal terminal rows of the electrical connector 10, and for each signal terminal row, each signal terminal 200 is in electrical contact with a corresponding conductive pad 31d on a corresponding one of the first surface 31a and the second surface 31b of the first mating portion 31. As described above and as shown in FIG. 1, the electrical connector 10 may be mounted to the second circuit board 5 such that the mounting end 202 of each of the plurality of signal terminals 200 is mounted onto the conductive pad 51a of the first conductive portion 51 of the second circuit board 5. In this way, it is possible to interconnect the first conductive portion 31c of the first circuit board 3 with the first conductive portion 51 of the second circuit board 5 by the plurality of signal terminals 200 of the electrical connector 10, so as to transmit signals between the first circuit board 3 and the second circuit board 5. The signals may be high-frequency signals, such as differential signals, or may be low-frequency signals.

As shown in the figures, each of the plurality of power terminals includes a mating end having a mating contact portion, a mounting end opposite to the mating end, and an intermediate portion connecting the mating end and the mounting end. The plurality of power terminals may be held in the insulative housing 100 such that the mating contact portions of the plurality of power terminals extend into the second slot portion 102 for mating with the second conductive portion 33c and the third conductive portion 33d of the second mating portion 33 of the first circuit board 3. The mounting ends of the plurality of power terminals may be configured to be mounted to the second conductive portion 52 and the third conductive portion 53 of the second circuit board 5. The intermediate portions of the power terminals may be configured for securing the power terminals in the insulative housing 100.

As shown in FIGS. 4 to 5I and 7, the plurality of power terminals may include a first group of power terminals 300A configured to transmit and/or carry a first voltage V1. The first group of power terminals 300A is disposed to be closer to the projection 103 of the insulative housing 100 in the longitudinal direction Y-Y than the remaining power terminals of the plurality of power terminals. The plurality of power terminals may also include a second group of power terminals 300B configured to transmit or carry a second voltage V2. The first voltage V1 is greater than the second voltage V2. The second group of power terminals 300B is disposed to be adjacent to the first group of power terminals 300A. For example, the first group of power terminals 300A is disposed in the insulative housing 100 in correspondence with a first section of the second slot portion 102, and the second group of power terminals 300B is disposed in the insulative housing 100 in correspondence with a second section of the second slot portion 102, wherein the first section of the second slot portion 102 is closer to the projection 103 in the longitudinal direction Y-Y than the second section. Thus, the first group of power terminals 300A are also closer to the plurality of signal terminals 200 than the second group of power terminals 300B.

With such a configuration, as will be described in detail below, the electrical connector 10 is capable of transmitting the first voltage V1 between the first circuit board 3 and the second circuit board 5 via the first group of power terminals 300A (For example, transmitting power at the first voltage V1), transmitting the second voltage V2 between the first circuit board 3 and the second circuit board 5 via the second group of power terminals 300B (For example, transmitting power at the second voltage V2), and transmitting signals between the first circuit board 3 and the second circuit board 5 via the plurality of signal terminals 200. Thus, a signal transmission section and a power transmission section can be integrated into the electrical connector 10, wherein the power transmission section at least includes two sections for transmitting power at the first voltage V1 and the second voltage V2 (the first voltage V1 is greater than the second voltage V2), respectively.

Such a configuration can enable the conductive terminals in the electrical connector 10 to be in a high-density arrangement while providing high-quality signal (e.g., high-speed signal) transmission and high power transmission. Disposing the first group of power terminals 300A to be closer to the projection 103 of the insulative housing 100 and closer to the plurality of signal terminals 200 than the second group of power terminals 300B can increase the creepage distance at a region adjacent to the projection 103 and the signal terminals 200. Furthermore, since the first voltage V1 transmitted by the first group of power terminals 300A is greater than the second voltage V2 transmitted by the second group of power terminals 300B, when the power transmitted by the first group of power terminals 300A is approximate to the power transmitted by the second group of power terminals 300B, the current passing through the first group of power terminals 300A is less than the current passing through the second group of power terminals 300B. Therefore, disposing the first group of power terminals 300A to be closer to the projection 103 of the insulative housing 100 and closer to the plurality of signal terminals 200 than the second group of power terminals 300B can provide better heat dissipation performance for the electrical connector 10, and is conducive to arranging the conductive terminals in the electrical connector 10 in a high-density arrangement, thereby facilitating the miniaturization of the electrical connector 10. In addition, disposing the first group of power terminals 300A to be closer to the plurality of signal terminals 200 than the second group of power terminals 300B can reduce interference with the signals transmitted by the signal terminals 200.

It should be appreciated that the first group of power terminals 300A and the second group of power terminals 300B may include any suitable form of power terminals as long as they are capable of realizing the aforementioned configurations of the electrical connector 10.

An exemplary power terminal version that can be used to realize the above configuration of the electrical connector 10 will be described below by taking an exemplary power terminal that can be used for the first group of power terminals 300A as an example. The power terminal of the first group of power terminals 300A may also be referred to as “a first power terminal 310.” As shown in FIGS. 4 to 5I and 7, the first group of power terminals 300A may be a pair of first power terminals 310. The pair of first power terminals 310 may be disposed facing each other and spaced apart from each other in the lateral direction X-X perpendicular to the vertical direction Z-Z and the longitudinal direction Y-Y across the second slot portion 102 (i.e., the first section of the second slot portion 102). The pair of first power terminals 310 may be configured for transmitting the first voltage V1. One of the pair of first power terminals 310 may be configured to be used as a supply path, and the other thereof may be configured to be used as a return path. In some embodiments, one of the first power terminals 310 of the pair of first power terminals 310 may be configured to be used as a positive electrode, and the other thereof may be configured to be used as a negative electrode.

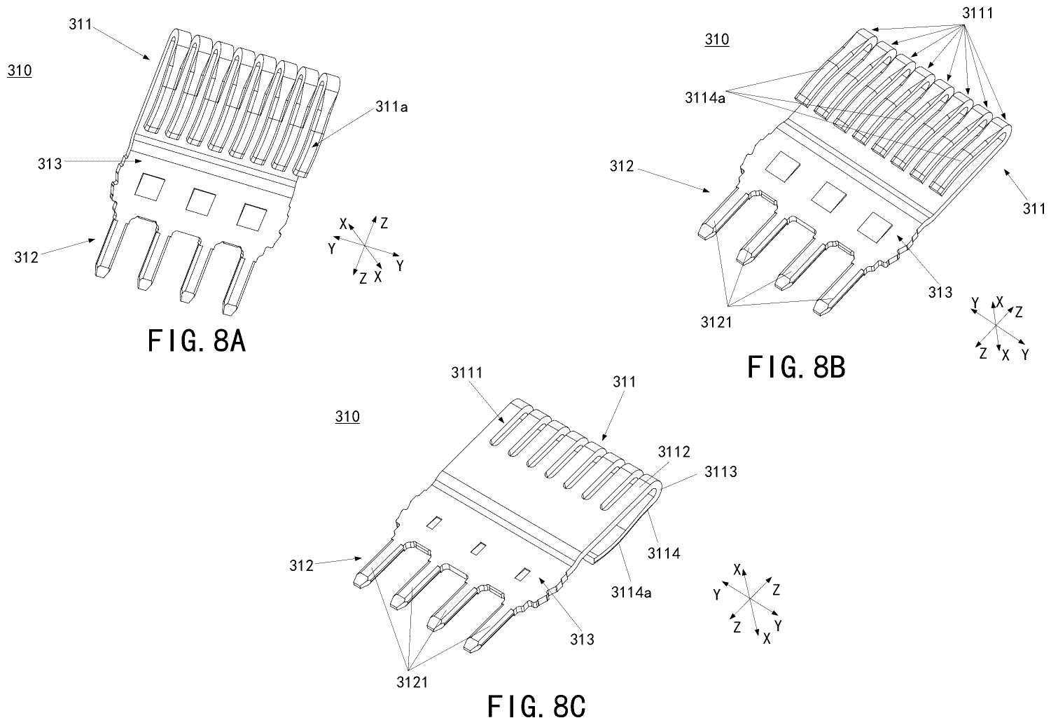

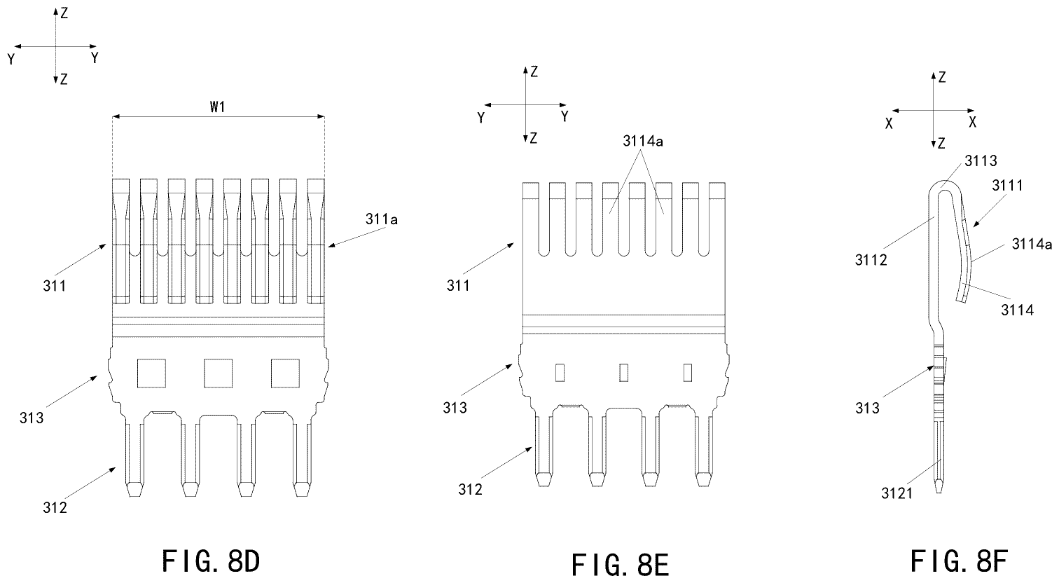

One first power terminal 310 is illustrated in detail in FIGS. 8A to 8F. The first power terminal 310 may include a mating end 311 having a mating contact portion 311a, a mounting end 312 opposite to the mating end 311, and an intermediate portion 313 connecting the mating end 311 and the mounting end 312. As will be described in detail below, the mating end 311 may be configured for mating with the second conductive portion 33c of the second mating portion 33 of the first circuit board 3, such that the mating contact portion 311a is in electrical contact with the corresponding first conductive continuous area 33c. The mounting end 312 may be configured to be mounted to a group of first conductive through holes 52a of the second conductive portion 52 of the second circuit board 5. The intermediate portion 313 may be configured for securing the first power terminals 310 in the insulative housing 100.

The first power terminal 310 may include a plurality of contact fingers 3111 extending from the intermediate portion 313. As shown in FIGS. 5G and 5I, the plurality of contact fingers 3111 may extend from the intermediate portion 313 towards the first face 100a and may be spaced apart from each other in the longitudinal direction Y-Y. In some embodiments, each contact finger 3111 may include a straight portion 3112, a curved portion 3113, and a contact portion 3114. As shown, the straight portion 3112 may extend from the intermediate portion 313 towards the first face 100a when the first power terminal 310 is disposed in the insulative housing 100. The curved portion 3113 may be connected between the straight portion 3112 and the contact portion 3114. The contact portion 3114 may extend from the curved portion 3113 away from the first face 100a (and towards the second face 100b) and include a contact region 3114a extending into the second slot portion 102. The plurality of contact fingers 3111 may together form the mating end 311 of the first power terminal 310, and the contact regions 3114a of the contact portions 3114 of the plurality of contact fingers 3111 may together form the mating contact portion 311a of the mating end 311. The contact regions 3114a of the plurality of contact fingers 3111 of the first power terminal 310 may together electrically contact a corresponding first conductive region 33e of the second mating portion 33 of the first circuit board 3. In some embodiments, as shown in FIGS. 8A to 8F, the number of contact fingers 3111 of the first power terminal 310 is eight. It should be appreciated that in some other embodiments, the number of contact fingers 3111 of the first power terminal 310 may be more or less than eight. Having more contact fingers 3111 may increase the current carrying capacity of the first power terminal 310.

The first power terminal 310 may further include a plurality of mounting tails 3121 extending from the intermediate portion 313 oppositely to the plurality of contact fingers 3111. Each mounting tail 3121 may be in the form of a straight portion. Each mounting tail 3121 may be configured to be mounted into a corresponding first conductive through hole 52a of a corresponding group of first conductive through holes 52a of the second conductive portion 52 of the second circuit board 5 so as to be electrically connected to the first conductive through hole 52a. The plurality of mounting tails 3121 may be mounted to the group of first conductive through holes 52a by, for example, a dual in-line package (DIP) technique. As shown in FIG. 5I, the plurality of mounting tails 3121 extend from the intermediate portion 313 away from the first face 100a towards the second face 100b and beyond the second face 100b for insertion into the first conductive through holes 52a of the second circuit board 5. The plurality of mounting tails 3121 may together form the mounting end 312 of the first power terminal 310. In some embodiments, as shown in FIGS. 8A to 8F, the number of mounting tails 3121 of the first power terminal 310 is four. It should be appreciated that in some other embodiments, the number of mounting tails 3121 of the first power terminals 310 may be more or less than four. Having more mounting tails 3121 may increase the current carrying capacity of the first power terminal 310.

As shown in FIGS. 5A, 5C to 5D, 5G to 5I, 6A, and 6C to 6D, the insulative housing 100 may include a pair of first accommodating portions 110 recessed into the insulative housing 100 from the second slot portion 102 in the lateral direction X-X. The pair of first accommodating portions 110 are disposed facing each other and spaced apart from each other in the lateral direction X-X across the second slot portion 102. The mating end 311 of each of the pair of first power terminals 310 may be disposed in a corresponding one of the pair of first accommodating portions 110 such that the mating contact portion 311a of the mating end 311 of the first power terminals 310 extends into the second slot portion 102.

As shown in FIGS. 5B, 5E, 5I, 6A to 6B, and 6D to 6E, the insulative housing 100 may further include a pair of first mounting grooves 130, each of which may be recessed into the insulative housing 100 from a corresponding one of the pair of first accommodating portions 110 away from the first face 100a in the vertical direction Z-Z, and may extend through the insulative housing 100 to the second face 100b in the vertical direction Z-Z. The intermediate portion 313 of the first power terminal 310 may be configured to be mounted in a corresponding first mounting groove 130 to retain the first power terminal 310 in the insulative housing 100. The plurality of mounting tails 3121 of the first power terminal 310 may extend through the corresponding first mounting groove 130 and beyond the second face 100b to be mounted to the second circuit board 5. In some embodiments, the intermediate portion 313 of the first power terminal 310 may be configured to engage with an inner wall of the first mounting groove 130 to retain the first power terminal 310 in the insulative housing 100. The intermediate portion 313 of the first power terminal 310 and/or the inner wall of the first mounting groove 130 of the insulative housing 100 may be provided with structures that help retain the first power terminal 310 in the insulative housing 100. In some other embodiments, the first power terminals 310 may also be retained in the insulative housing 100 by any other suitable retention structure such as an insulative terminal retention member, or the insulative housing 100 may be overmolded over the first power terminals 310 to retain the first power terminals 310 in the insulative housing 100.

Each power terminal of the second group of power terminals 300B may also be referred to as “a second power terminal 320.” As shown in FIGS. 4 to 5I and 7, the second group of power terminals 300B may be a plurality of pairs of second power terminals 320, and each pair of second power terminals 320 may be disposed facing each other and spaced apart from each other across the second slot portion 102 in the lateral direction X-X. Each pair of the plurality of pairs of second power terminals 320 may be configured to transmit the second voltage V2. One of each pair of second power terminals 320 may be configured to be used as a power supply path, and the other thereof may be configured to be used as a return path. In some embodiments, one of each pair of second power terminals 320 may be configured to be used as a positive electrode and the other thereof may be configured to be used as a negative electrode.

As shown in FIG. 4, the first power terminal 310 and the second power terminal 320 may have the same configurations. The mating end 321, the mounting end 322, and the intermediate portion 323 of the second power terminal 320 may be the same as the mating end 311, the mounting end 312, and the intermediate portion 313 of the first power terminal 310, respectively. It should be appreciated that although the mating end 321, the mounting end 322, and the intermediate portion 323 of the second power terminal 320 are marked in FIGS. 4 to 5I and 7, the first power terminal 310 may have corresponding portions.

The mating end 321 of the second power terminal 320 may be configured for mating with the third conductive portion 33d of the second mating portion 33 of the first circuit board 3 such that the mating contact portion 321a electrically contacts the second conductive region 33f. The mounting end 322 may be configured to be mounted to the second conductive through hole 53a of the third conductive portion 53 of the second circuit board 5. The intermediate portion 323 may be configured to secure the second power terminal 320 in the insulative housing 100.

As shown in FIGS. 5A, 5C to 5D, 5G to 5I, 6A, and 6C to 6D, the insulative housing 100 may further include a plurality of pairs of second accommodating portions 120 recessed into the insulative housing 100 from the second slot portion 102 in the lateral direction X-X. Each pair of second accommodating portions 120 may be disposed facing each other and spaced apart from each other across the second slot portion 102 in the lateral direction X-X. The mating end 321 of each second power terminal 320 of each pair of second power terminals 320 is disposed in a corresponding second accommodating portion 120 of a corresponding pair of the plurality of pairs of second accommodating portions 120 such that the mating contact portion 321a of the mating end 321 of the second power terminal 320 extends into the second slot portion 102.

As shown in FIGS. 5B, 5E, 5I, 6A to 6B, and 6D to 6E, the insulative housing 100 may further include a plurality of second mounting grooves 140. The first mounting groove 130 and the second mounting groove 140 may have the same structures. Each of the second mounting grooves 140 may be recessed into the insulative housing 100 from a corresponding second accommodating portion 120 of the plurality of pairs of second accommodating portions 120 in the vertical direction Z-Z away from the first face 100a, and may extend through the insulative housing 100 to the second face 100b in the vertical direction Z-Z. The plurality of mounting tails 3221 of the mounting end 322 of the second power terminal 320 may extend through a corresponding second mounting groove 140 and beyond the second face 100b to be mounted to the second circuit board 5. Similar to those described above in connection with the first power terminal 310 and the first mounting groove 130, the intermediate portion 323 of the second power terminal 320 may be configured to be mounted in the corresponding second mounting groove 140 to retain the second power terminal 320 in the insulative housing 100. In some embodiments, the intermediate portion 323 of the second power terminal 320 may be configured to engage with an inner wall of the second mounting groove 140 to retain the second power terminal 320 in the insulative housing 100. The intermediate portion 323 of the second power terminal 320 and/or the inner wall of the second mounting groove 140 of the insulative housing 100 may be provided with features that help to retain the second power terminals 320 in the insulative housing 100. In some other embodiments, the second power terminals 320 may also be retained in the insulative housing 100 by any other suitable retention structure such as an insulative terminal retention member, or the insulative housing 100 may be overmolded over the second power terminals 320 to retain the second power terminals 320 in the insulative housing 100.

As shown in FIGS. 4, 5D, and 7, the first group of power terminals 300A and the second group of power terminals 300B may be arranged in two power terminal rows disposed facing each other and spaced apart from each other across the second slot portion 102 in the lateral direction X-X. The two power terminal rows are labeled with R1 and R2 in FIG. 7, respectively. The power terminals in each of the two power terminal rows R1 and R2 may be aligned with and spaced apart from each other in the longitudinal direction Y-Y.

As described above, each power terminal of the pair of first power terminals 310 and the plurality of pairs of second power terminals 320 may include a mating end having a mating contact portion. The mating end 311 of each first power terminal 310 may be disposed in a corresponding one of the pair of first accommodating portions 110 such that the mating contact portion 311a of the mating end 311 of the first power terminal 310 extends into the second slot portion 102. The mating end 321 of each second power terminal 320 may be disposed in a corresponding second accommodating portion of the plurality of pairs of second accommodating portions 120 such that the mating contact portion 321a of the mating end 321 of the second power terminal 320 extends into the second slot portion 102.

When the second mating portion 33 of the first circuit board 3 is inserted into the second slot portion 102 of the insulative housing 100 of the electrical connector 10 in a manner as shown in FIG. 1, the second mating portion 33 is positioned between the two power terminal rows R1 and R2, and for each of the power terminal rows, the mating contact portion of each of the first power terminal 310 and the second power terminal 320 electrically contacts a corresponding one of the plurality of conductive regions (the first conductive regions 33e and the second conductive regions 33f) of a corresponding one of the first surface 33a and the second surface 33b. For example, the mating contact portion 311a of each first power terminal 310 is in electrical contact with a corresponding first conductive region 33e, and the mating contact portion 321a of each second power terminal 320 is in electrical contact with a corresponding second conductive region 33f. As described above and as shown in FIG. 1, the electrical connector 10 may be mounted to the second circuit board 5 such that the mounting end 312 of each first power terminal 310 of the pair of first power terminals 310 is mounted to a corresponding first conductive through hole 52a of the second conductive portion 52 of the second circuit board 5, and such that the mounting end 322 of each second power terminal 320 of each pair of the plurality of pairs of second power terminals 320 is mounted to a corresponding second conductive through hole 53a of the third conductive portion 53 of the second circuit board 5.

In this way, it is possible to interconnect the second conductive portion 33c of the first circuit board 3 and the second conductive portion 52 of the second circuit board 5 via the pair of first power terminals 310 of the electrical connector 10 to transmit power at the first voltage V1 between the first circuit board 3 and the second circuit board 5, and it is possible to interconnect the third conductive portion 33d of the first circuit board 3 and the third conductive portion 53 of the second circuit board 5 via the plurality of pairs of second power terminals 320 to transmit power at the second voltage V2 between the first circuit board 3 and the second circuit board 5.

As shown in FIG. 5D, for each of the two power terminal rows R1 and R2, the mating contact portion 311a of the first power terminal 310 and the mating contact portion 321a of a corresponding adjacent second power terminal 320 (i.e., the second power terminal 320 of the same row that is closest to the first power terminal 310 in the longitudinal direction Y-Y) may be spaced center-to-center from each other in the longitudinal direction Y-Y by a first spacing P1, and the mating contact portions 321a of every two adjacent second power terminals 320 may be spaced center-to-center from each other in the longitudinal direction Y-Y by a second pitch P2. In some embodiments, as shown in FIG. 5D, the first spacing P1 is greater than the second pitch P2. Such a configuration can reduce the interference between the power transmitted by the first power terminals 300A and the power transmitted by the second power terminals 300B, and can provide better heat dissipation performance for the electrical connector 10. It should be appreciated that every two adjacent conductive regions of the first conductive regions 33e and the second conductive regions 33f on the first circuit board 3 may also be spaced apart from each other by a similar pitch.

For example, the first spacing P1 may be greater than 8.5 mm, and the second pitch P2 may be less than or equal to 8.5 mm. In some examples, the first spacing P1 may be 9.1 mm, and the second pitch P2 may be 8.5 mm. Such a configuration can enable the power terminals in the electrical connector 10 to be arranged in a high-density arrangement while providing high power transmission.

As shown in FIG. 5D, for each of the two power terminal rows R1 and R2, the mating contact portion 311a of the first power terminal 310 and the mating contact portion 321a of a corresponding adjacent second power terminal 320 may be spaced edge-to-edge from each other in the longitudinal direction Y-Y by a third pitch P3, and the mating contact portions 321a of every two adjacent second power terminals 320 may be spaced edge-to-edge from each other by a fourth pitch P4. In some embodiments, as shown in FIG. 5D, the third pitch P3 is greater than the fourth pitch P4. In one of these embodiments, the third pitch P3 may be greater than 1.0 mm, and the fourth pitch may be less than 1.0 mm. The third pitch P3 may be 1.5 mm. The fourth pitch may be 0.9 mm.

As shown in FIG. 5D, the mating contact portion 311a of the first power terminal 310 may have a first width W1 in the longitudinal direction Y-Y, and the mating contact portion 321a of the second power terminal 320 may have a second width W2 in the longitudinal direction Y-Y. In some embodiments, for example, when the first power terminal 310 and the second power terminal 320 have the same configurations, as shown in FIG. 5D, the first width WI is equal to the second width W2. For example, the first width W1 and the second width W2 may be 7.6 mm. It should be appreciated that the present application is not intended to be limited in this aspect.

In some embodiments, each of the first power terminal 310 and the second power terminals 320 of one of the two power terminal rows R1 and R2 is configured to be used as a positive electrode, and each of the first power terminal 310 and the second power terminals 320 of the other of the power terminal rows is configured to be used as a negative electrode.

As shown in FIGS. 4 to 6D, every two adjacent ones of the first containment portion 110 and the second containment portions 120 may be separated from each other in the longitudinal direction Y-Y by a rib of the insulative housing 100. For example, for each of the two power terminal rows R1 and R2, every two adjacent power terminals of the first power terminal 310 and the second power terminals 320 are separated from each other by the rib of the insulative housing 100. With such a configuration, it is possible to increase the creepage distance between the two adjacent power terminals, thereby enabling the power terminals in the electrical connector 10 to be arranged in a high-density arrangement while providing high power transmission.

As shown in FIG. 5D, each first accommodating portion 110 and a corresponding adjacent second accommodating portion 120 may be separated from each other in the longitudinal direction Y-Y by a first rib 151 of the ribs of the insulative housing 100, and the first rib 151 may have a third width W3 in the longitudinal direction Y-Y. Every two adjacent second accommodating portions 120 may be separated from each other in the longitudinal direction Y-Y by a second rib 152 of the ribs of the insulative housing 100, and the second rib 152 may have a fourth width W4 in the longitudinal direction Y-Y. In some embodiments, the third width W3 may be greater than the fourth width W4. In one of these embodiments, the third width W3 of the first rib 151 may be greater than 1.0 mm, and the fourth width W4 of the second rib 152 may be less than 1.0 mm. The third width W3 may be 1.05 mm. The fourth width W4 may be less than 0.5 mm, such as 0.45 mm. As shown in FIG. 6A, the housing 100 may include a third rib 153 disposed between the first slot portion 101 and the second slot portion 102.

In some embodiments, as shown in FIG. 6C, the insulative housing 100 may include heat emission holes 160 each communicating each of the first accommodating portions 110 and the second accommodating portions 120 with an outer sidewall of the insulative housing 100 in the lateral direction X-X. By providing the heat emission holes 160, it is possible to help reduce the temperature within the second slot portion 102, thereby improving the power transmission performance of the electrical connector 10.

In some embodiments, each of the first power terminals 310 and the second power terminals 320 may be configured to be capable of carrying a current of 30 amperes with a temperature rise of no more than 30 degrees Celsius, such as in the absence of the heat emission holes 160.

In some embodiments, the first voltage V1 is 48V and the second voltage V2 is 12V. In this case, for example, as described above and shown in FIGS. 4 to 5G, the first group of power terminals 300A may include a pair of first power terminals 310, and the second group of power terminals 300B may include four pairs of second power terminals 320. For example, the first voltage V1 is four times greater than the second voltage V2, and the number of power terminals of the first group of power terminals 300A is one-fourth of the number of power terminals of the second group of power terminals 300B. In some other embodiments, the first group of power terminals 300A of the electrical connector 10 includes a first number of power terminals, and the second group of power terminals 300B includes a second number of power terminals, and the first number is less than the second number. For example, the first voltage V1 may be N times greater than the second voltage V2, and the first number may be one Nth of the second number, wherein N is an integer greater than one.

Turning back to FIG. 1, the present application also proposes an electronic system 1 including: the aforementioned electrical connector 10; the first circuit board 3, which may include the first mating portion 31 and the second mating portion 33, the first mating portion 31 may be configured for insertion into the first slot portion 101 of the electrical connector 10 and have the first conductive portion 31c, and the second mating portion 33 may be configured for insertion into the second slot portion 102 of the electrical connector 10 and have the second conductive portion 33c and the third conductive portion 33d; and the second circuit board 5, which may have the first conductive portion 51, the second conductive portion 52, and the third conductive portion 53. The electrical connector 10 is mounted to the second circuit board 5, and the first mating portion 31 and the second mating portion 33 of the first circuit board 3 are inserted into the first slot portion 101 and the second slot portion 33 of the electrical connector 10, respectively, such that: the plurality of signal terminals 200 of the electrical connector 10 interconnect the first conductive portion 31c of the first circuit board 3 and the first conductive portion 51 of the second circuit board 5 to transmit signals therebetween; the first group of power terminals 300A of the electrical connector 10 interconnect the second conductive portion 33c of the first circuit board 3 and the second conductive portion 52 of the second circuit board 5 to transmit the first voltage V1 therebetween; and the second group of power terminals 300B of the electrical connector 10 interconnect the third conductive portion 33d of the first circuit board 3 and the third conductive portion 53 of the second circuit board 5 to transmit the second voltage V2 therebetween. In some embodiments, the first circuit board 3 may be a voltage regulator module (VRM). For example, the VRM may receive and regulate the first voltage V1 to provide the second voltage V2. Techniques described herein may enable a VRM to be disposed closer to an input power (e.g., first voltage V1) on a circuit board (e.g., a motherboard) through connectors described herein, reducing losses that may be caused by longer transmission distance and increasing energy efficiency.

Although details of specific configurations of the electronic system 1 and the electrical connector 10 are described above, it should be appreciated that such details are provided solely for the purposes of illustration, as the concepts disclosed herein are capable to be implemented in other manners. In that respect, the various electronic system 1 and electrical connector 10 designs described herein may be used in any suitable combination, as aspects of the present disclosure are not limited to the particular combinations shown in the drawings.

It should be appreciated that although the above exemplary configuration that can be used for the electrical connector 10 are described in connection with exemplary configurations of the first power terminals 310 and the second power terminals 320, the present application is not intended to be limited in this aspect, and any other suitable version of power terminals may be used in the electrical connector 10. These power terminals may meet the voltage-quantity relationship as previously described.

It should also be appreciated that the relationship between the number of power terminals between the first group of power terminals 300A and the second group of power terminals 300B may be independent of the multiplier relationship between the first voltage and the second voltage.

It should also be appreciated that the electrical connector 10 may be configured as any other suitable type of connector. The electrical connector 10 may be configured as a straddle-mounted electrical connector or a right-angle electrical connector.

It should also be appreciated that the terms “first”, “second”, “third”, and “fourth” are only used to distinguish an element, component or portion from another element, component or portion, and that these elements, components or portions should not be limited by such terms.

The present application has been described above in detail in conjunction with specific embodiments. Obviously, the above description and the embodiments shown in the appended drawings should be understood to be exemplary and do not constitute any limitations on the present application. For a person skilled in the art, various variations or modifications can be made without departing from the spirit of the present application, and these variations or modifications shall fall within the scope of the present application.

What is claimed is:

1. An electrical connector, comprising:
a housing comprising a mating face and a slot recessed into the mating face;
a plurality of power conductive elements held by the housing, each of the plurality of power conductive elements comprising a mating end having a plurality of contact fingers, a mounting end having a plurality of mounting tails, and an intermediate portion between the mating end and the mounting end, each of the plurality of contact fingers comprising a contact region disposed in the slot; and
a plurality of signal conductive elements, each of the plurality of signal conductive elements comprising a mating end having a mating contact portion disposed in the slot, a mounting end, and an intermediate portion between the mating end and the mounting end, wherein:
the plurality of power conductive elements comprise first, second, and third power conductive elements, the second power conductive element disposed between the first and third power conductive elements;
the second power conductive element is spaced from the first power conductive element by a first center-to-center spacing;
the second power conductive element is spaced from the third power conductive element by a second center-to-center pitch less than the first center-to-center spacing; and
adjacent signal conductive elements of the plurality of signal conductive elements are spaced from each other by a third center-to-center pitch less than the first center-to-center spacing.

2. The electrical connector of claim 1, wherein:
the first power conductive element is configured for transmitting a first voltage;
each of the second and third power conductive elements are configured for transmitting a second voltage; and
the first voltage is a multiple of the second voltage.

3. The electrical connector of claim 2, wherein:
the plurality of power conductive elements comprises fourth and fifth power conductive elements each configured for transmitting the second voltage; and
the first voltage is 48V and the second voltage is 12V.

4. The electrical connector of claim 3, wherein:
each of the plurality of power conductive elements is configured to carry a current of 30 amperes with a temperature rise in a range of 0 to 30 degrees.

5. The electrical connector of claim 3, wherein:
the fourth power conductive element is disposed between the third and fifth conductive elements and spaced from the third and fifth power conductive elements by the second center-to-center pitch;
the first center-to-center spacing is 9.1 mm; and
the second center-to-center pitch is 8.5 mm.

6. The electrical connector of claim 1, wherein:
the plurality of mounting tails of the mounting end of each of the plurality of power conductive elements are configured for inserting into a circuit board; and
the mounting end of each of the plurality of signal conductive elements is configured for surface mount to the circuit board.

7. The electrical connector of claim 5, wherein:
the third center-to-center pitch is 0.65 mm.

8. The electrical connector of claim 6, wherein the housing comprises:
a first rib disposed between the first and second conductive elements of the plurality of power conductive elements;
a second rib disposed between the second and third conductive elements of the plurality of power conductive elements, the second rib narrower than the first rib in a direction the slot of the housing elongated; and
a third rib disposed between the plurality of signal conductive elements and the first conductive element of the plurality of power conductive elements, the third rib wider than the first rib in the direction the slot of the housing elongated.

9. The electrical connector of claim 8, wherein the housing comprises:
a projection extending from a bottom of the housing into the slot and disposed between the plurality of signal conductive elements and the first conductive element of the plurality of power conductive elements.

10. An electrical connector, comprising:
a housing comprising a mating face and a slot recessed into the mating face;
a plurality of conductive elements held by the housing and disposed in two rows on opposite sides of the slot, each of the two rows of conductive elements comprising a plurality of signal terminals and a plurality of power terminals, wherein, for each of the two rows:
the plurality of power terminals comprise a first power terminal and a number of second power terminals, wherein the number is at least two;
the first power terminal is spaced edge-to-edge from an adjacent second power terminal of the number of second power terminals by a first distance;
adjacent second power terminals of the number of second power terminals are spaced edge-to-edge from each other by a second distance less than the first distance in a direction the slot elongated; and
the first power terminal is disposed between the plurality of signal terminals and the number of second power terminals and spaced edge-to-edge from the plurality of signal terminals by a third distance greater than the first distance in the direction the slot elongated.

11. The electrical connector of claim 10, wherein:
the first power terminal is configured for transmitting a first voltage;
each of the number of second power terminals is configured for transmitting a second voltage; and
the first voltage is equal to the second voltage multiplied by the number.

12. The electrical connector of claim 10, wherein:
the two rows of conductive elements have mating contact portions disposed in the slot.

13. The electrical connector of claim 12, wherein:
the first power terminal and the number of second power terminals in one of the two rows are configured for positive electrodes; and
the first power terminal and the number of second power terminals in the other of the two rows are configured for negative electrodes.

14. The electrical connector of claim 10, wherein:
the housing comprises, on each side of the opposite sides of the slot, a first accommodating portion and a plurality of second accommodating portions recessed into a side wall of the housing from the slot; and
for each of the two rows of the conductive elements:
each power terminal of the first power terminal and the number of second power terminals comprises a mating end having a mating contact portion;
the mating end of the first power terminal is disposed in the first accommodating portion such that the mating contact portion of the mating end of the first power terminal extends into the slot; and
the mating end of each of the number of second power terminals is disposed in a corresponding second accommodating portion of the plurality of second accommodating portions such that the mating contact portion of the mating end of the second power terminal extends into the slot.

15. The electrical connector of claim 14, wherein:
the side wall of the housing comprises a plurality of holes extending therethrough.

16. The electrical connector of claim 14, wherein the housing comprises, on each side of the opposite sides of the slot:
a first rib disposed between the first accommodating portion and an adjacent second accommodating portion of the plurality of second accommodating portions;
a plurality of second ribs each disposed between adjacent second accommodating portions of the plurality of second accommodating portions; and
each of the plurality of second ribs is narrower than the first rib in a direction the slot elongated.

17. The electrical connector of claim 10, wherein, for each of the two rows:
each of the plurality of power terminals comprises a mating end having a plurality of contact fingers, a mounting end having a plurality of mounting tails, and an intermediate portion between the mating end and the mounting end;
each of the plurality of contact fingers comprises a straight portion, a curved portion, and a contact portion;
the straight portion extends from the intermediate portion towards the mating face;
the curved portion connects the straight portion and the contact portion; and
the contact portion extends from the curved portion away from the mating face and comprises a contact region extending into the slot.

18. The electrical connector of claim 17, wherein:
the plurality of mounting tails are at least four mounting tails; and
the plurality of contact fingers are at least eight contact fingers.

19. An electronic system, comprising:
an electrical connector comprising:
a housing comprising a mating face and a slot recessed into the mating face;
a plurality of conductive elements held by the housing and each comprising a mating contact portion disposed in the slot and a mounting end extending out of the housing, the plurality of conductive elements comprising a plurality of signal terminals and a plurality of power terminals;
a first circuit board comprising a mating portion inserted into the slot of the electrical connector and first circuitry connected to the mating portion and configured to regulate a first voltage to a second voltage different from the first voltage, the mating portion of the first circuit board comprising a plurality of contact pads contacting respective mating contact portions of the plurality of conductive elements; and
a second circuit board comprising a plurality of conductive portions contacting respective mounting ends of the plurality of conductive elements and second circuitry supplying the first voltage, the second circuitry connected to at least a conductive portion of the plurality of conductive portions; wherein:
the plurality of power terminals of the electrical connector comprises a first power terminal connected to the at least a conductive portion connected to the second circuitry supplying the first voltage and a plurality of second power terminals each configured for transmitting the second voltage.

20. The electronic system of claim 19, wherein:
the plurality of signal terminals of the electrical connector comprise mounting ends for surface mount to the second circuit board; and
the plurality of power terminals of the electrical connector comprise mounting ends for inserting into the second circuit board.
